(19) United States
(12) Patent Application Publication
(10) Pub. No.: US 2025/0320969 A1
(43) Pub. Date: Oct. 16, 2025

(54) GAS CONTAINER HAVING VALVE-COUPLING ASSEMBLY CONNECTED TO OUTER VALVE

(71) Applicant: HNX CO., LTD., Seoul (KR)

(72) Inventors: Yongguk OH, Goyang-si (KR); Bumsug PARK, Gimhae-si (KR); Taejeong NOH, Changwon-si (KR)

(21) Appl. No.: 19/251,631

(22) Filed: Jun. 26, 2025

Related U.S. Application Data
(63) Continuation of application No. PCT/KR2022/021752, filed on Dec. 30, 2022.

(51) Int. Cl. F17C 13/04

(52) U.S. Cl. CPC F17C 13/04; F17C 2201/0104; F17C 2203/0604; F17C 2203/0673; F17C 2205/0308; F17C 2205/0329; F17C 2205/0394

(57) ABSTRACT

Disclosure is a gas container including: a liner including a space to store gas therein; a valve coupling unit coupled to an outer valve as a metal material, and including a passage for the gas injected through the outer valve; a fusion member provided along an outer circumferential surface of the valve coupling unit, and fused between the valve coupling unit and the liner; a nozzle communicating with the passage of the valve coupling unit, and including an opening to guide the injected gas to be sprayed into the liner; and a protective cap fitted to a region of the fusion member as a plastic material, and shaped to extend between the opening and the exposed end portion so that the exposed end portion of the valve coupling unit disposed in a direction where the opening of the nozzle is oriented cannot come into contact with the sprayed gas. Accordingly, the protective cap improves the airtight sealing of the exposed end portion of the valve coupling unit against gas injected and sprayed into the liner of the gas container, and thus a gap is prevented from formation between the valve coupling unit and the fusion member having a thermal deformation rate different from that of the valve coupling unit, thereby preventing gas leakage accidents.

### REFERENCE TO RELATED APPLICATIONS

This is a continuation of International Patent Application PCT/KR2022/021752 filed on Dec. 30, 2022, the entire contents of which are incorporated herein by reference.

### FIELD OF THE INVENTION

The disclosure relates to a gas container manufactured by blow molding, and more particularly to a gas container having a valve-coupling assembly connected to an outer valve.

### BACKGROUND OF THE INVENTION

A gas container includes a liner that forms a space to store high-pressure gas therein. The liners made of metal have been conventionally used, but plastic liners have recently become widespread. The plastic liners are lighter than the metal liners and thus contribute to the portability of the gas container.

The gas container includes a valve-coupling assembly for connection with an outer valve. The valve-coupling assembly is also referred to as a boss module. The valve-coupling assembly includes a plastic fusion member for connection with the liner, and a metal valve coupling unit for connection with a metal outer valve. Typically, the valve coupling unit and the fusion member are coupled by insert injection molding to prevent the high-pressure gas from leaking out therethrough.

Meanwhile, to reduce the risk of a gas explosion during the injection of gas into the gas container, the direction of a nozzle opening is set so that the gas can be injected along the inner circumferential surface of the liner. In this case, one end of the valve coupling unit disposed in the direction of the nozzle opening is unavoidably exposed to direct contact with the injected gas. This end of the valve coupling unit is deformed when coming into contact with the low-temperature gas. As a result, a gap is formed due to the difference in a thermal deformation rate between the valve coupling unit and the fusion member, thereby allowing the gas to leak out through the gap.

Accordingly, there is an increasing demand for a gas container, in which a valve coupling unit is prevented from deformation due to contact with gas and a gap is prevented from formation between the valve coupling unit and a fusion member having a thermal deformation rate different from that of the valve coupling unit, thereby preventing gas leakage accidents.

### SUMMARY OF THE INVENTION

An aspect of the disclosure is to provide a gas container, in which a region of a valve coupling unit coming into contact with gas sprayed toward a liner of the gas container is minimized to prevent the valve coupling unit from deformation due to the gas, and a gap is prevented from formation between the valve coupling unit and a fusion member having a thermal deformation rate different from that of the valve coupling unit to prevent gas leakage accidents.

According to an embodiment of the disclosure, a gas container includes: a liner including a space to store gas therein; a valve coupling unit coupled to an outer valve as a metal material, and including a passage for the gas injected through the outer valve; a fusion member provided along an outer circumferential surface of the valve coupling unit, and fused between the valve coupling unit and the liner; a nozzle communicating with the passage of the valve coupling unit, and including an opening to guide the injected gas to be sprayed into the liner; and a protective cap fitted to a region of the fusion member as a plastic material, and shaped to extend between the opening and the exposed end portion so that the exposed end portion of the valve coupling unit disposed in a direction where the opening of the nozzle is oriented cannot come into contact with the sprayed gas.

The protective cap minimizes the exposed end portion of the valve coupling unit that comes into contact with gas injected and sprayed into the liner of the gas container, and thus a gap is prevented from formation between the valve coupling unit and the fusion member having a thermal deformation rate different from that of the valve coupling unit, thereby preventing gas leakage accidents.

The protective cap may include a base portion that comes into contact with a lower end portion including a region of the fusion member; a fixing projection that protrudes from one surface of the base portion and is fitted into a fixing groove provided at the lower end portion of the fusion member; and a bent portion that is bent from the base portion and extends between the opening and the exposed end portion.

Thus, the protective cap is firmly coupled to the fusion member, and thus the minimization of the exposed end portion that comes into contact with gas is maintained for a long period of time.

The protective cap may be formed of a material having higher elasticity than the fusion member.

Thus, an operation of fitting the protective cap onto the fusion member is facilitated.

The gas container may further include at least one sealing member interposed between an inner circumferential surface of the valve coupling unit extending from the exposed end portion and an outer circumferential surface of the nozzle.

When the sealing member is interposed between the inner circumferential surface of the fusion member made of a plastic material and the outer circumferential surface of the nozzle, the inner circumferential surface of the fusion member is likely to be pressed and deformed by the sealing member, and the gas may leak through the gap between the deformed inner circumferential surface of the fusion member and the outer circumferential surface of the nozzle. However, when the sealing member is interposed between the outer surface of the nozzle and the inner circumferential surface of the exposed end portion made of a metal material, the inner circumferential surface of the exposed end portion is unlikely to be pressed or deformed by the sealing member, thereby preventing gas leakage accidents between the inner circumferential surface of the exposed end portion and the outer surface of the nozzle.

The bent portion includes an end portion extended to come into contact with the nozzle.

Thus, the exposed end portion that comes into contact with the gas may be further minimized.

According to an embodiment of the disclosure, a gas container includes: a liner including a space to store gas therein; a valve coupling unit coupled to an outer valve as a metal material, and including a passage for the gas injected through the outer valve; a fusion member provided along an outer circumferential surface of the valve coupling unit, and fused between the valve coupling unit and the liner; a nozzle communicating with the passage of the valve coupling unit, and including an opening to guide the injected gas to be sprayed into the liner; and at least one sealing member interposed between an inner circumferential surface of the exposed end portion of the valve coupling unit disposed in a direction where the opening of the nozzle is oriented and an outer circumferential surface of the nozzle.

When the sealing member is interposed between the inner circumferential surface of the fusion member made of a plastic material and the outer circumferential surface of the nozzle, the inner circumferential surface of the fusion member is likely to be pressed and deformed by the sealing member, and the gas may leak through the gap between the deformed inner circumferential surface of the fusion member and the outer circumferential surface of the nozzle. However, when the sealing member is interposed between the outer surface of the nozzle and the inner circumferential surface of the exposed end portion made of a metal material, the inner circumferential surface of the exposed end portion is unlikely to be pressed or deformed by the sealing member, thereby preventing gas leakage accidents between the inner circumferential surface of the exposed end portion and the outer surface of the nozzle.

According to the disclosure, there is provided a gas container, in which a region of a valve coupling unit coming into contact with gas injected and sprayed toward a liner of the gas container is minimized to prevent the valve coupling unit from deformation due to the gas, and a gap is prevented from formation between the valve coupling unit and a fusion member having a thermal deformation rate different from that of the valve coupling unit to prevent gas leakage accidents.

### BRIEF DESCRIPTION OF THE DRAWINGS

FIG. 1 is an exploded view of a gas container according to an embodiment of the disclosure.

FIG. 2 is an exploded view of a valve coupling unit according to the embodiment of the disclosure shown in FIG. 1.

FIG. 3 is an assembled view of the gas container according to the embodiment of the disclosure shown in FIG. 1.

FIG. 4 is an exploded view of the valve coupling unit according to the embodiment of the disclosure shown in FIG. 1.

### DETAILED DESCRIPTION OF THE INVENTION

Below, embodiments of the disclosure will be described with reference to the accompanying drawings. Throughout the accompanying drawings, like reference numerals may refer to like components.

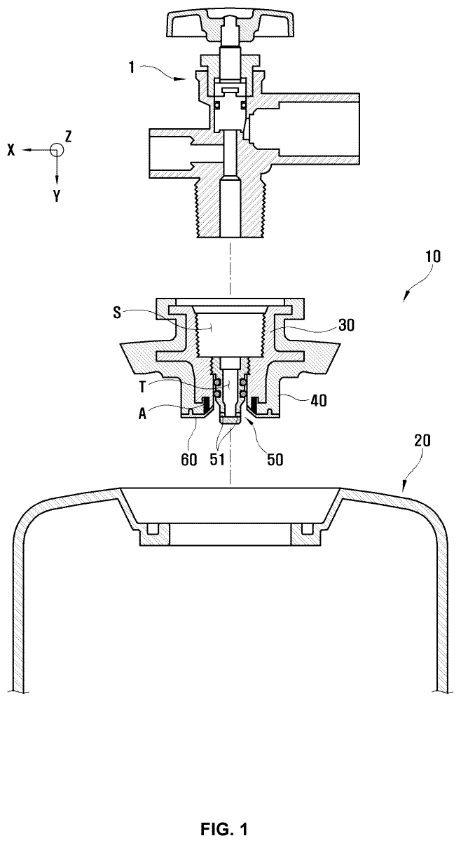

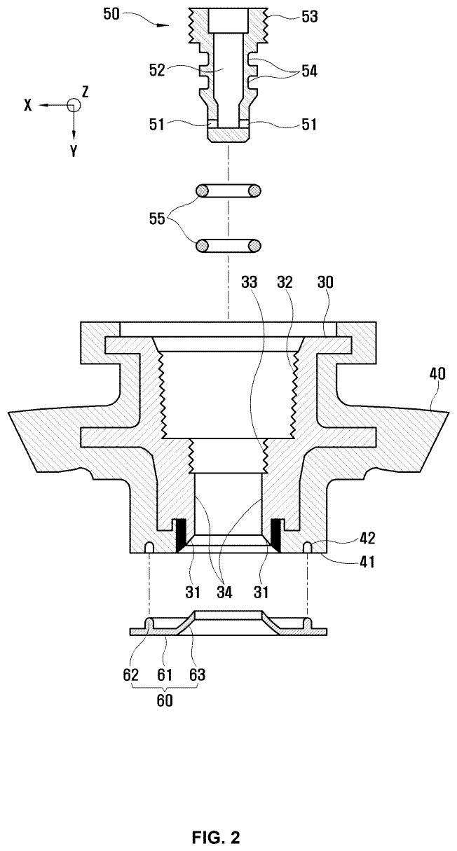

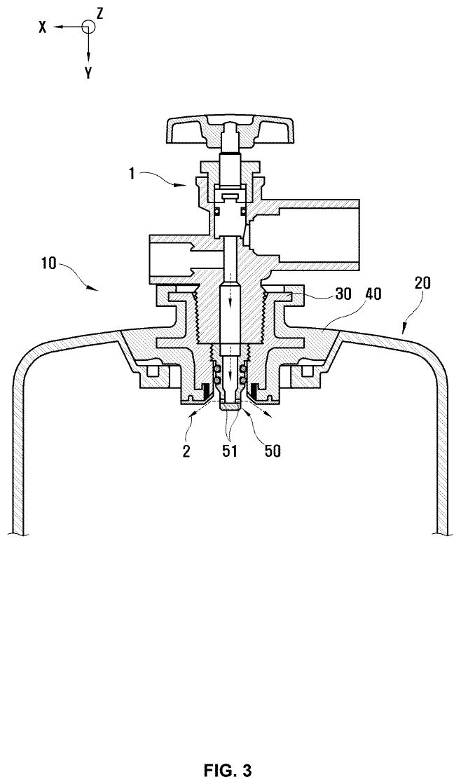

FIG. 1 is an exploded view of a gas container 10 according to an embodiment of the disclosure, FIG. 2 is an exploded view of a valve coupling unit 30 according to the embodiment of the disclosure shown in FIG. 1, and FIG. 3 is an assembled view of the gas container 10 according to the embodiment of the disclosure shown in FIG. 1.

Below, the components of the gas container 10 and a process of minimizing an exposed end portion 31 of the valve coupling unit 30 coming into contact with gas 2 sprayed into the inside of the gas container 10 will be described in detail with reference to FIGS. 1 to 3.

As shown in FIG. 1, the gas container 10 includes a liner 20. The liner 20 may be made of plastic and manufactured by blow molding. The liner 20 is shaped like a cylinder, and has a space to store the gas 2 therein. Considering that the gas 2 is stored at high pressure, the outer circumferential surface of the liner 20 may be wound with a reinforcing material such as fiber reinforced plastics (FRP).

The gas container 10 includes the valve coupling unit 30. The valve coupling unit 30 is coupled to a metal outer valve 1, and has a valve accommodating space S to accommodate the valve 1 and couple with the valve 1. The valve accommodating space S may include a passage via which the gas 2 injected through the valve 1 is supplied along an axial line C of the valve coupling unit 30. The valve coupling unit 30 may be made of metal to couple with the valve 1. For example, the valve coupling unit 30 may be made of brass.

The gas container 10 includes a fusion member 40. The fusion member 40 is provided along the outer circumferential surface of the valve coupling unit 30, and is fused between the valve coupling unit 30 and the liner 20. Specifically, the fusion member 40 is fused along the outer circumferential surface of the valve coupling unit 30 by insert injection molding, and is fused to the liner 20 by a thermal fusion method based on ultrasonic welding or the like. The fusion member 40 may be made of plastic such as high-density polyethylene (HDPE).

Such a configuration including the valve coupling unit 30 and the fusion member 40 may be referred to as a valve-coupling assembly or a boss module. The valve-coupling assembly refers to a configuration for coupling the metal valve 1 to the plastic liner 20. To ensure the stability of coupling with the liner 20 and the stability of injecting the gas 2, respective regions of the valve coupling unit 30 and the fusion member 40 are disposed within the space of the liner 20.

The gas container 10 includes a nozzle 50. The nozzle 50 has a cylindrical shape extending in the Y-axis direction, and has a passage T communicating with the valve accommodating space S of the valve coupling unit 30. The nozzle 50 has an opening 51 so that the gas 2 injected through the valve 1 accommodated in the valve accommodating space S can be guided to be sprayed into the liner 20. The opening 51 is provided at an end portion of the nozzle 50 in the Y-axis direction. To spray the gas 2, the end portion of the nozzle 50 with the opening 51 is inserted into the space of the liner 20 when the nozzle 50 is coupled to the valve coupling unit 30.

There may be provided a plurality of openings 51. For example, the openings 51 may be provided at the end portion of the nozzle 50 on both sides in the X-axis direction, thereby guiding the gas 2 injected from the valve 1 to be sprayed simultaneously on both sides in the X-axis direction.

For example, when the gas 2 is injected through the opening 51 oriented in the Y-axis direction, there is a concern that a spark may occur due to the difference in polarity between the gas 2 and the air inside the liner 20 and lead to an explosion. For this reason, the opening 51 is oriented in the X-axis direction so that the gas 2 can be gradually filled along the inner circumferential surface of the liner 20.

The gas container 10 includes a protective cap 60. The protective cap 60 is fitted into a region of the fusion member 40, and is shaped to extend between the opening 51 and the exposed end portion 31 so that the exposed end portion 31 of the valve coupling unit 30 disposed in the direction where the opening 51 of the nozzle 50 is oriented cannot come into contact with the sprayed gas 2. The exposed end portion 31 refers to a region of the valve coupling unit 30 disposed inside the space of the liner 20, and means one end portion of the valve coupling unit 30 disposed in the spraying direction of the gas 2 when the gas 2 is sprayed on both sides in the X-axis direction through the opening 51 of the nozzle 50.

The absence of the protective cap 60 increases the area that comes into contact with the low-temperature gas 2 sprayed from the opening 51 of the nozzle 50 placed within the space of the liner 20, thereby causing the deformation of the valve coupling unit 30. Due to the difference in the thermal deformation rate or the coefficient of thermal expansion between the valve coupling unit 30 and the fusion member 40, the deformation of the valve coupling unit 30 causes a gap between the valve coupling unit 30 and the fusion member 40. Because the gas 2 is stored inside the liner 20 at high pressure, the gas 2 may leak through the gap.

Therefore, the exposed end portion 31 of the valve coupling unit 30 is surrounded with the protective cap 60 in the gas container 10 according to this embodiment, thereby minimizing a region of the exposed end portion 31 that comes into contact with the gas 2. As a result, the valve coupling unit 30 is prevented from deformation, and a gap is prevented from formation between the valve coupling unit 30 and the fusion member 40 having a thermal deformation rate different from that of the valve coupling unit 30, thereby preventing gas leakage accidents.

According to various embodiments, the gas container 10 may further include an adhesive member A interposed between the outer circumferential surface of the exposed end portion 31 and the inner circumferential surface of the fusion member 40 facing the outer circumferential surface of the exposed end portion 31. Although the exposed end portion 31 is deformed due to the contact with the gas 2, the adhesive member A serves to compensate for the deformation so that a gap cannot be formed between the outer circumferential surface of the fusion member 40 and the exposed end portion 31.

According to various embodiments, the valve coupling unit 30 includes a valve fastening portion 32 to coupling with the valve 1. The valve 1 may have a shape corresponding to the valve fastening portion 32 and include a configuration to couple with the valve fastening portion 32.

At the lower end of the valve fastening portion 32 in the Y-axis direction, a nozzle fastening portion 33 is provided to couple with the nozzle 50. Further, a nozzle passage portion 34 may be provided at the lower end of the nozzle fastening portion 33 in the Y-axis direction. The nozzle passage portion 34 serves to guide the end of the nozzle 50 in the Y-axis direction to easily enter the space of the liner 20 when the nozzle 50 is coupled to the valve coupling unit 30.

On the outer circumferential surface of an upper end portion of the nozzle 50, a valve fastening portion 53 is provided having a shape corresponding to the foregoing nozzle fastening portion 33 of the valve coupling unit 30 and coupled to the nozzle fastening portion 33. The nozzle fastening portion 33 and the valve fastening portion 53 may be provided to be screw-coupled.

According to various embodiments, the protective cap 60 includes a base portion 61, a fixing projection 62, and a bent portion 63.

The base portion 61 comes into contact with a lower end portion 41 including a region of the fusion member 40. The base portion 61 may be shaped corresponding to the shape of the lower end portion 41 of the fusion member 40. For example, when the lower end portion 41 of the fusion member 40 is parallel to the X-axis direction, the base portion 61 may also be shaped like a plate parallel to the X-axis direction. With this shape, airtight sealing between the base portion 61 and the lower portion 41 of the fusion member 40 may be improved.

The fixing projection 62 protrudes from one surface of the base portion 61 and is fitted into a fixing groove 42 provided at the lower end portion 41 of the fusion member 40. The fixing projection 62 is shaped corresponding to the fixing groove 42 so as to be fitted into the fixing groove 42. The fixing projection 62 is fitted into the fixing groove 42 so that the protective cap 60 can be firmly coupled to the fusion member 40. It is advantageous in terms of manufacturability to form the fixing groove 42, into which the fixing projection 62 is fitted, at the lower end portion 41 of the plastic fusion member 40 rather than at a region or the exposed end portion 31 of the metal valve coupling unit 30.

The bent portion 63 is bent from the base portion 61 and extends between the opening 51 of the nozzle 50 and the exposed end portion 31 of the valve coupling unit 30. For example, the bent portion 63 may extend from one end of the valve coupling unit 30 facing the axial line C between both ends of the base portion 61 extending in the X-axis direction toward a direction between the opening 51 and the exposed end portion 31, i.e., a direction between the −Y-axis direction and the Z-axis direction.

The bent portion 63 may be shaped corresponding to the shape of the exposed end portion 31. For example, when the exposed end portion 31 extends in the direction between the −Y-axis direction and the Z-axis direction, the base portion 61 may also be shaped like a plate parallel to that direction. With this shape, airtight sealing between the bent portion 63 and the exposed end portion 31 may be improved.

By using the protective cap 60 with this configuration, the minimization of the exposed end portion 31 that is firmly coupled to the fusion member 40 and comes into contact with the gas 2 may be maintained for a long period of time.

As a reference example, when the exposed end portion is minimized as integrated with the fusion member 40, for example, extended from the fusion member 40, it is impossible to cover the exposed end portion, which comes into contact with the low-temperature gas 2, with a material different from that of the existing fusion member 40. However, according to this embodiment, the protective cap 60 manufactured with a material different from that of the fusion member 40, such as a material resistant to low-temperature brittleness, may be selected to cover the exposed end portion 31. For example, styrene butadiene rubber (SBR), acrylonitrile butadiene styrene (ABS), etc. may be used. In addition, when the protective cap 60 is manufactured separately, a manufacturing operation may be facilitated compared to that of when the protective cap 60 is manufactured integrally with the fusion member 40.

According to various embodiments, the protective cap 60 may be formed of a material having higher elasticity than the fusion member 40. When the protective cap 60 is made of the material having higher elasticity than the fusion member 40, a fitting operation onto the fusion member 40 may be facilitated. The foregoing materials such as SBR, ABS, etc. are not only resistant to low-temperature brittleness, but also have higher elasticity than the fusion member 40, thereby making the fitting operation easier.

According to various embodiments, the gas container 10 includes at least one sealing member 55 interposed between the inner circumferential surface of the valve coupling unit 30 extending from the exposed end portion 31 and the outer circumferential surface of the nozzle 50. The inner circumferential surface of the valve coupling unit 30 extending from the exposed end portion 31 includes an inner circumferential surface of the nozzle passage 34 that does not come into contact with the protective cap 60.

On the outer circumferential surface of the nozzle 50 between the upper and lower end portions thereof may be provided a groove 54 into which the sealing member 55 is fitted or fixed. When a plurality of grooves 54 are provided, the sealing members 55 may be fitted into the grooves 54, respectively. For convenience of description, it is assumed that two grooves 54 are provided in the Y-axis direction and two sealing members 55 are fitted into the two grooves 54, respectively.

When the sealing member 55 is interposed between the inner circumferential surface of the fusion member 40 and the outer circumferential surface of the nozzle 50, the inner circumferential surface of the fusion member 40 made of a plastic material having lower strength than a metal material is likely to be pressed and deformed by the sealing member 55, and the gas 2 may leak through the gap between the deformed inner circumferential surface of the fusion member 40 and the outer circumferential surface of the nozzle 50.

According to this embodiment, the inner circumferential surface of the valve coupling unit 30 extending from the exposed end portion 31 is unlikely to be pressed or deformed by the sealing member 55 even though the sealing member 55 is interposed between the outer surface of the nozzle 50 and the inner circumferential surface of the valve coupling unit 30 extending from the exposed end portion 31 made of a metal material, thereby preventing gas leakage accidents between the inner circumferential surface of the valve coupling unit 30 and the outer surface of the nozzle 50.

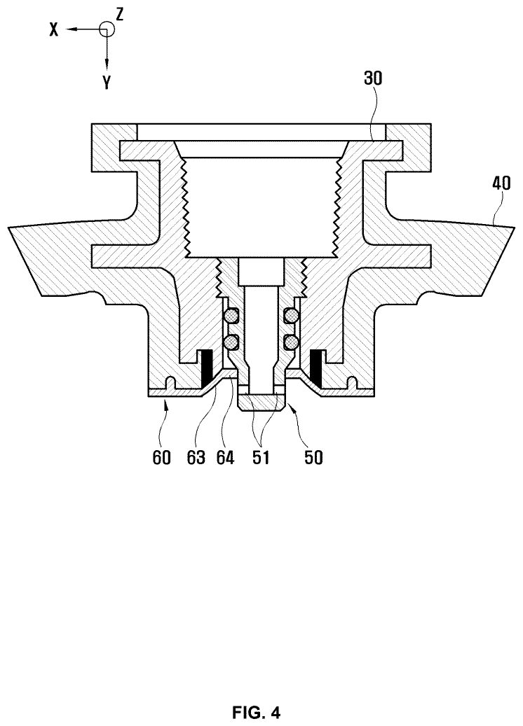

FIG. 4 is an exploded view of the valve coupling unit 30 according to the embodiment of the disclosure shown in FIG. 1.

Below, repetitive descriptions to the protective cap 60 described above with reference to FIGS. 1 to 3 will be omitted, and detailed descriptions will be provided focusing on the differences.

As shown in FIG. 4, the protective cap 60 according to this embodiment includes the base portion 61 and the bent portion 63 extended and bent from one end of the base portion 61. In particular, the bent portion 63 has an end portion 64 extended to come into contact with the nozzle 50. For convenience of description, the extended end portion 64 will be referred to as an extended portion 64. For example, the extended portion 64 may be extended in a direction toward the axis line C of the valve coupling unit 30 between both ends of the bent portion 63. When the extended portion 64 is used in addition to the bent portion 63, a region for blocking the gas 2 is expanded, so that the airtight sealing of the exposed end portion 31 against the gas 2 can be further improved.

According to various embodiments, the extended portion 64 may be extended to come into contact with the outer circumferential surface of the nozzle 50. Thus, the airtight sealing of the exposed end portion 31 against the gas 2 may be further improved compared to the case where the extended portion 64 is extended without coming into contact with the outer circumferential surface of the nozzle 50.

Although a few exemplary embodiments of the disclosure have been described in detail, the disclosure is not limited thereto and may be implemented in various ways within the scope defined in the appended claims.

What is claimed is:

1. A gas container comprising:
a liner comprising a space to store gas therein;
a valve coupling unit coupled to an outer valve as a metal material, and comprising a passage for the gas injected through the outer valve;
a fusion member provided along an outer circumferential surface of the valve coupling unit, and fused between the valve coupling unit and the liner;
a nozzle communicating with the passage of the valve coupling unit, and comprising an opening to guide the injected gas to be sprayed into the liner; and
a protective cap fitted to a region of the fusion member as a plastic material, and shaped to extend between the opening and the exposed end portion so that the exposed end portion of the valve coupling unit disposed in a direction where the opening of the nozzle is oriented cannot come into contact with the sprayed gas.

2. The gas container of claim 1, wherein the protective cap comprises:
a base portion that comes into contact with a lower end portion including a region of the fusion member;
a fixing projection that protrudes from one surface of the base portion and is fitted into a fixing groove provided at the lower end portion of the fusion member; and
a bent portion that is bent from the base portion and extends between the opening and the exposed end portion.

3. The gas container of claim 1, wherein the protective cap is formed of a material having higher elasticity than the fusion member.

4. The gas container of claim 1, further comprising at least one sealing member interposed between an inner circumferential surface of the valve coupling unit extending from the exposed end portion and an outer circumferential surface of the nozzle.

5. The gas container of claim 2, wherein the bent portion comprises an end portion extended to come into contact with the nozzle.
